(19) United States
(12) Patent Application Publication
(10) Pub. No.: US 2024/0403647 A1
(43) Pub. Date: Dec. 5, 2024

(54) GENERALIZED EVOLUTIONARY TRAINING FRAMEWORKS FOR DEEP NEURAL NETWORKS

(71) Applicant: Apollo Autonomous Driving USA LLC, Sunnyvale, CA (US)

(72) Inventors: Weiman LIN, Sunnyvale, CA (US); Yu CAO, Sunnyvale, CA (US); Hao LIU, Sunnyvale, CA (US); Ang LI, Sunnyvale, CA (US)

(73) Assignee: Apollo Autonomous Driving USA LLC, Sunnyvale, CA (US)

(21) Appl. No.: 18/327,707

(22) Filed: Jun. 1, 2023

(51) Int. Cl. G06N 3/086

(52) U.S. Cl. CPC G06N 3/086

(57) ABSTRACT

Embodiments of a methodology for generalized evolutionary training of a neural network may comprise: (i) obtaining a set of model snapshots by training a set of input models until at least one snapshot condition is satisfied for each input model from the set of input models, wherein each model snapshot comprises values of model components of its respective input model when the at least one snapshot condition was satisfied; (ii) generating model snapshot evaluation results by evaluating performance of each model snapshot; (iii) based upon the model snapshot evaluation results, selecting one or more parent models from the set of model snapshots; (iv) generating one or more child models by perturbing at least one or more model components of a parent model from the one or more parent models; and (v) setting the one or more child models as the set of input models for a subsequent training iteration.

### BACKGROUND

### A. Technical Field

The present disclosure relates generally to systems and methods for machine learning that can provide improved computer, device, or model performance, features, and uses. More particularly, the present disclosure relates to a generalized evolutionary training framework for neural networks.

It shall be noted that the subject matter discussed in the background section should not be assumed to be prior art merely because of it being mentioned in this background section. Similarly, a problem mentioned in the background section or associated with the subject matter of the background section should not be assumed to have been previously recognized in the prior art. The subject matter in the background section merely represents different approaches, which in and of themselves may also be inventions.

### B. Background

Neural networks are a type of machine learning model that include layers of interconnected nodes that process information and learn to make predictions or classifications or perform other types of inferences. In one example, a neural network can receive input data and process the data via forward propagation and back propagation, which allows the neural network to adjust its parameters to minimize the difference between its predicted output and an actual output (ground truth). Neural networks are used in a wide range of applications, such as image recognition, natural language processing, speech recognition, predictive analytics, vehicle navigation, etc.

Optimizing neural networks can be a challenging task for various reasons. One challenge is tuning/training a suitable set of model parameters (e.g., weights and/or biases of the connections between nodes) that achieve a desired level of performance or accuracy while still enabling the model to generalize for new sets of input data (e.g., avoiding overfitting). Tuning/training processes can be computationally expensive, which can limit the ability of systems to quickly and/or efficiently train models to handle new problems.

Another challenge is finding the optimal set of hyperparameters (e.g., configuration settings, learning rates, model architecture (e.g., number of layers, types of layers, skip connections, branching, etc.), regularization values, etc.) that govern the architecture and behavior of the neural network. Hyperparameters can include the number of layers, types of layers, number of nodes in each layer, learning rate, kernel size, stride, activation functions, and/or other aspects that affect model architecture, accuracy, behavior, and/or efficiency. In contrast with parameters, which are learned using training data, hyperparameters are typically set by a developer or data scientist through trial-and-error processes, which can be time-consuming and/or inefficient.

Accordingly, what is needed are improved training frameworks for deep neural networks.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

Figure (“FIG.”) 1A depicts a conceptual representation of utilizing a base model to obtain a first set of model snapshots and evaluating performance of the first set of model snapshots, according to embodiments of the present disclosure.

FIG. 1B and FIG. 1C depict a conceptual representation of selecting parent models from the first set of model snapshots based upon evaluation results and obtaining child models from the parent models via perturbation, according to embodiments of the present disclosure.

FIG. 1D depicts a conceptual representation of utilizing the child models to obtain a second set of model snapshots and evaluating performance of the second set of model snapshots, according to embodiments of the present disclosure.

FIG. 1E and FIG. 1F depict a conceptual representation of selecting additional parent models from the second set of model snapshots based upon evaluation results and obtaining additional child models from the parent models via perturbation, according to embodiments of the present disclosure.

FIG. 1G depicts a conceptual representation of selecting a final model in response to detecting satisfaction of a convergence condition based upon evaluation results, according to embodiments of the present disclosure.

FIG. 2, FIG. 3, and FIG. 4 depict example flow diagrams including acts associated with generalized evolutionary training, according to embodiments of the present disclosure.

FIG. 5 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded. A set may contain any number of elements, including the empty set.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### A. General Introduction

As noted above, optimizing neural networks is associated with various challenges, such as selecting hyperparameters and tuning parameters in an efficient manner that yields desirable results. Some conventional model tuning processes may utilize a trainer component and an evaluator component. Given a set of hyperparameters, a trainer component may be configured to tune model parameters to output a trained model (e.g., via forward propagation and backpropagation). An evaluator component may be configured to evaluate performance metrics of a trained model, such as, by way of non-limiting example, accuracy, precision, recall, mean squared error, mean absolute error, and/or others.

Trainer and evaluator components may be utilized in various training frameworks, such as a parallel search framework or a sequential optimization framework. In a parallel search framework, multiple trainer components may operate in parallel to independently train a population of models (e.g., each being trained using a slightly varied set of hyperparameters), and one or more evaluator components may assess performance of the models of the trained population to select a final model. Grid search and random search are examples of parallel search frameworks.

In a sequential optimization framework, a trainer component receives a fixed set of hyperparameters and tunes a model, which is then provided to the evaluator component to assess performance of the tuned model. Based upon the performance of the tuned model, a new set of hyperparameters may be sampled/obtained. Another sequential optimization iteration may then be performed by tuning a subsequent model via the trainer component using the new set of hyperparameters. The subsequently tuned model may then also be evaluated by the evaluator component to influence sampling/selection of another new set of hyperparameters. Sequential optimization iterations may be performed until a stop or convergence condition is satisfied (e.g., when model performance as determined by the evaluator component is satisfactory). Bayesian optimization and hand tuning are example sequential optimization frameworks.

In one or more embodiments, parallel search may be performed in a more efficient manner than sequential optimization by utilizing distributed systems to independently train the models of the population. However, sequential optimization can often provide a model with superior performance than a model obtained by parallel search by using previous training results to influence hyperparameter selection for subsequent trainings.

At least some disclosed embodiments are directed to generalized training frameworks for training neural networks, which may be referred to for convenience as a generalized evolutionary training (GET) framework or frameworks. At least some model training techniques disclosed herein utilize aspects of population-based training and perturbation techniques to enable automatic and efficient tuning of any type of learning-based model.

In one or more embodiments, a system utilizes a set of trainer components to train a first generation of models. The training may be performed until a snapshot condition is satisfied (e.g., after performance of a predetermined number of iterations), at which point a model snapshot may be acquired for each model in the first generation. The model snapshot for each model may capture the model state at a particular point in time and may include model components/information such as model parameters, hyperparameters, etc.

Continuing with the above example, the system may utilize a set of evaluator components to evaluate performance of each of the model snapshots in the first generation. The system may then utilize a selector to select parent models from the first-generation model snapshots based upon the evaluated performance of the model snapshots. By selecting parent models based on performance metrics from model snapshots (which in many instances have not reached a state of convergence), disclosed systems may efficiently facilitate evolution toward models with desirable characteristics without fully fine-tuning models within each generation. Such functionality can contribute to an overall process that achieves desirable models in less time and with less computational expense.

Continuing with the above example, the system may utilize a set of perturber components to generate a second generation of models (i.e., child models) by perturbing model components of the selected parent models, such as hyperparameters and/or parameters (e.g., weights). Model perturbation as described herein can additionally, or alternatively, implement aspects of reproduction in evolutionary training. The second generation of models may then be further trained in a warm-start manner (owing to the parameters and/or hyperparameters of the second-generation models obtained by perturbation) to obtain an additional set of model snapshots. The additional set of model snapshots may be evaluated and used as the basis to select an additional set of parent models for forming a third generation of models (e.g., child models formed by perturbation of the additional set of parent models). Generations of models may be obtained in an iterative manner until a convergence condition is satisfied, at which point the system may output one or more final models that may be deployed for inference.

Perturbing model parameters to generate child models as discussed herein can contribute to improved mitigation of performance degradation during warm start training of the child models (for forming new model snapshots). Perturbing model hyperparameters as discussed herein can cause the hyperparameters to dynamically change over time, which can contribute to broader exploration of a model search space to find a desirable set of model characteristics (e.g., in contrast to training frameworks where model hyperparameters are hardcoded).

In one or more embodiments, perturbation configurations and/or parent model selection conditions may be influenced by hyperparameter trajectories, which may represent changes to hyperparameters over time (brought about by perturbation) and/or may represent the effect on model performance of changes to hyperparameters. Such hyperparameter trajectories may be tracked in association with models throughout their evolution. Utilizing hyperparameter trajectories to influence parent model selection and/or perturbation characteristics can contribute to achieving a desirable set of model characteristics in less time and/or with less computational expense.

### B. Generalized Evolutionary Training Embodiments

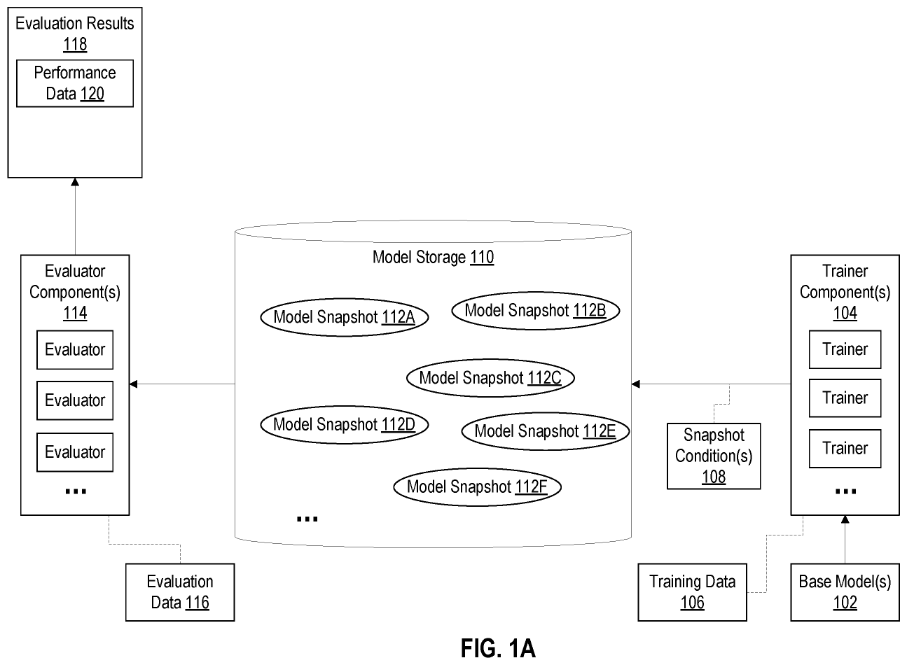

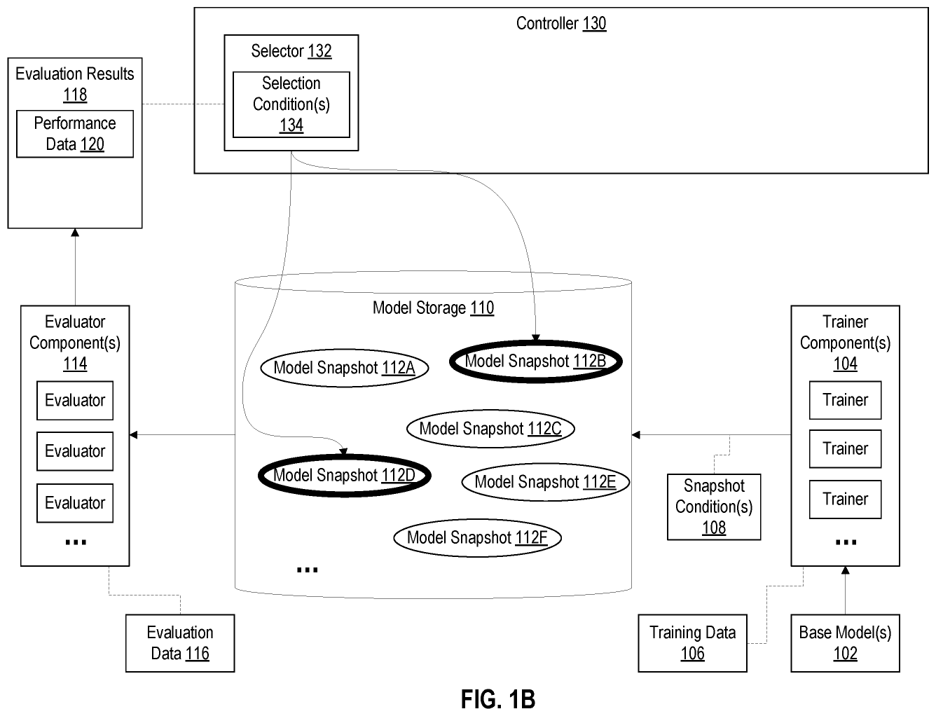

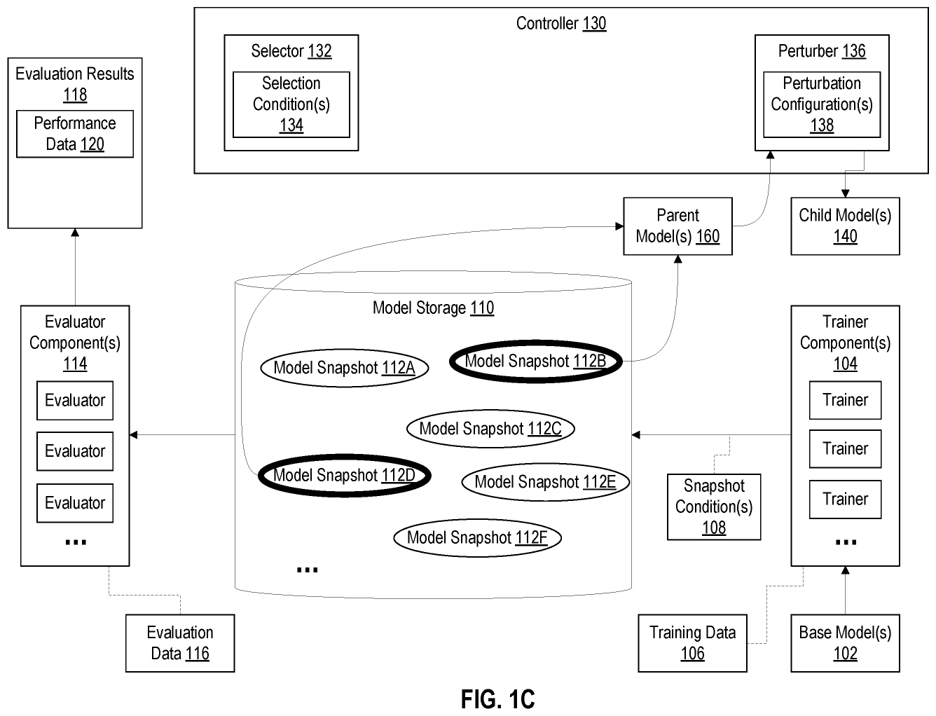

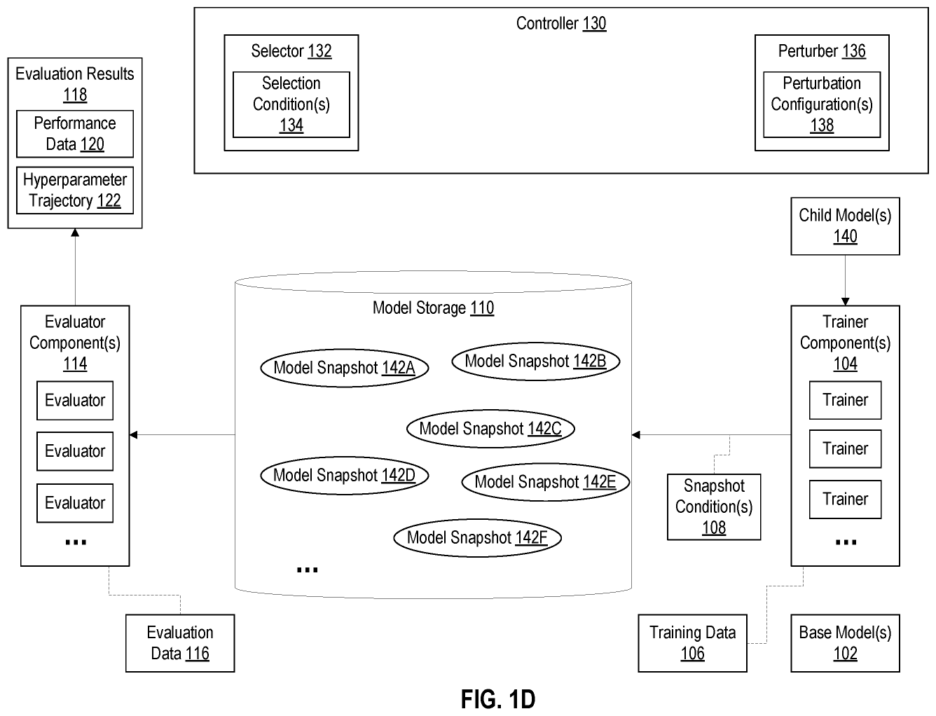

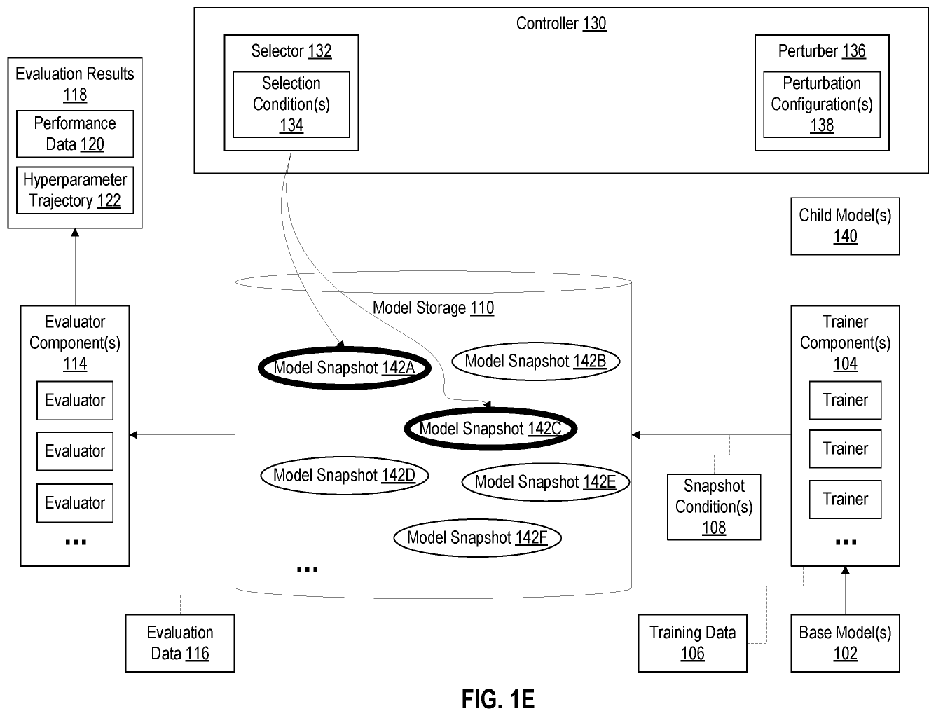

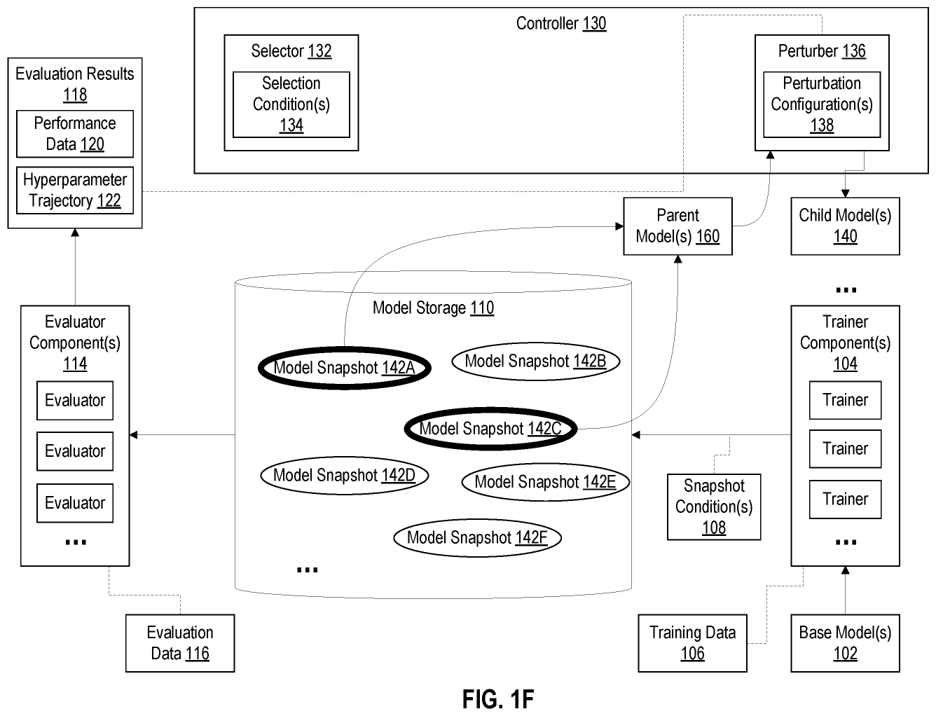

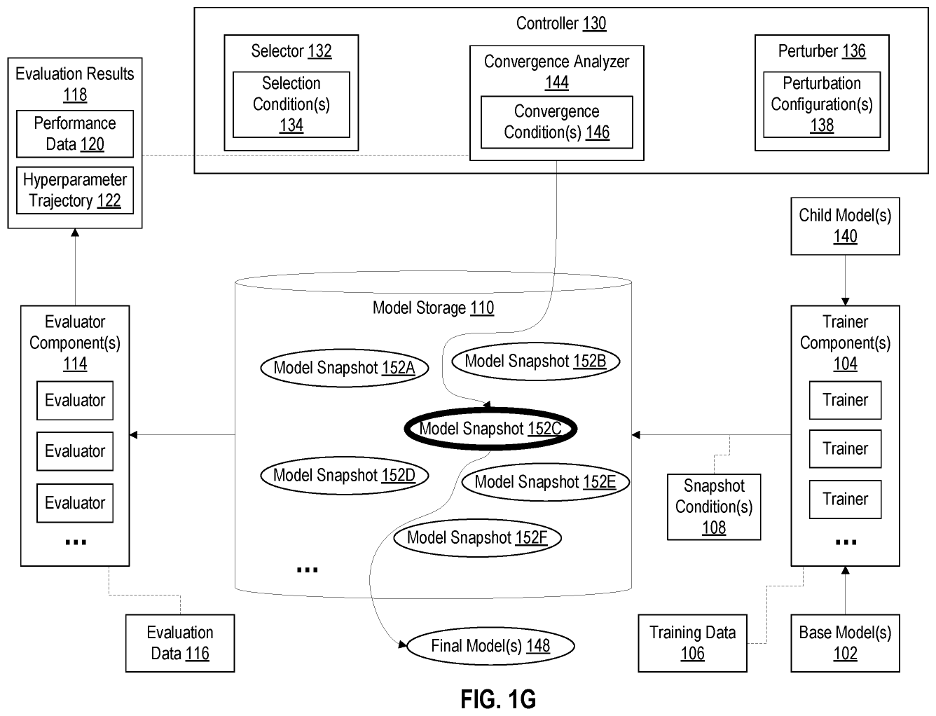

FIGS. 1A through 1G conceptually depict various aspects, operations, components, and features associated with generalized evolutionary training for obtaining models that can be deployed for inference. FIG. 1A depicts one or more base models 102 utilized as an input to trainer component(s) 104. The base model(s) 102 may comprise one or more initial models with initial parameters and/or hyperparameters. In one or more embodiments, the initial parameters of the base model(s) 102 are initialized using conventional techniques (e.g., random initialization, orthogonal initialization, and/or others) and hyperparameters are sampled randomly. In one or more embodiments, the hyperparameters (and/or the parameters) of the base model(s) 102 are manually configured by a user and/or are selected based upon machine learning or other initialization operations (e.g., neural architecture search (NAS)).

The trainer component(s) 104 may receive and train the base model(s) 102 (as depicted in FIG. 1A by the arrow extending from the base model(s) 102 to the trainer component(s) 104). The trainer component(s) 104 may comprise one or more individual trainers that may operate synchronously or asynchronously. The ellipsis within the trainer component(s) 104 indicates that any quantity of individual trainers may be included in the trainer component(s) 104. In one or more embodiments, the trainer component(s) 104 may train the base model(s) 102 (or any input model(s)) in a distributed and/or parallelized manner, which can contribute to computational and/or time efficiency. The trainer component(s) 104 may utilize training data 106 to train the base model(s) 102. The training data 106 may comprise input data (e.g., image data, text data, or any type) and ground truth labels (e.g., classifications, predictions, recommendations, cluster definitions, etc.) to facilitate training of the base model(s) 102 utilizing any suitable training methodologies (e.g., forward propagation and backpropagation). In one or more embodiments, the trainer component(s) 104 sample subsets of training data from the training data 106 to facilitate training of the base model(s) 102.

In the embodiment of FIG. 1A, the trainer component(s) 104 may train the base model(s) 102 until one or more snapshot conditions 108 are satisfied, at which point one or more trained models may be output from the trainer component(s) 104. In one or more embodiments, the snapshot condition(s) 108 may be satisfied before trainer component(s) 104 have trained the base model(s) 102 to convergence. The snapshot condition(s) 108 may take on various forms, such as completion of a predetermined number of training iterations or epochs (e.g., 10,000 iterations, 1 epoch, or another quantity), amount of training or processing time, or full or partial convergence. The snapshot condition(s) 108 may be defined by users. In response to satisfaction of the snapshot condition(s) 108, which may occur at different times for different trainers of the trainer component(s) 104, a system acquires model snapshots for the trained (base) models and stores them within model storage 110, as indicated in FIG. 1A by the arrow extending from the trainer component(s) 104 to the model storage 110. The model snapshots are depicted in FIG. 1A as model snapshots 112A, 112B, 112C, 112D, 112E, and 112F within the model storage 110. The ellipsis within the model storage 110 indicates that any quantity of model snapshots may be determined (e.g., commensurate with the quantity of base model(s) 102 trained by the trainer component(s) 104).

In the embodiment of FIG. 1A, the model snapshots 112A, 112B, 112C, 112D, 112E, and 112F include the states or values of model components of the trained base model(s) at a particular point in time (e.g., when the snapshot condition(s) 108 were satisfied during training by the trainer component(s) 104). The model components represented in the model snapshots may comprise parameters, hyperparameters, and/or other data types that affect model architecture, accuracy, behavior, and/or efficiency.

FIG. 1A furthermore depicts the model snapshots 112A, 112B, 112C, 112D, 112E, and 112F of the model storage 110 being processed by evaluator component(s) 114 (indicated in FIG. 1A by the arrow extending from the model storage 110 toward the evaluator component(s) 114). The evaluator component(s) 114 may comprise any quantity of individual evaluators (as indicated by the ellipsis within the evaluator component(s) 114). Similar to the trainers of the trainer component(s) 104, the evaluators of the evaluator component(s) 114 may operate synchronously, asynchronously, utilizing distributed resources, in parallel, etc. The evaluator component(s) 114 may comprise one or more processing modules configured for evaluating various aspects of model performance, such as, by way of non-limiting example, accuracy, precision, recall, mean squared error, mean absolute error, and/or others.

The evaluator component(s) 114 may utilize evaluation data 116 (e.g., comprising input data and ground truth labels) to facilitate such performance evaluation. For instance, the evaluator component(s) 114 may provide input data from the evaluation data 116 to the model snapshots 112A, 112B, 112C, 112D, 112E, and 112F and compare output labels assigned by the model snapshots 112A, 112B, 112C, 112D, 112E, and 112F to ground truth labels represented in the evaluation data to assess performance of the model snapshots 112A, 112B, 112C, 112D, 112E, and 112F. FIG. 1A depicts evaluation results 118 including performance data 120 obtained by processing of the model snapshots 112A, 112B, 112C, 112D, 112E, and 112F by the evaluator component(s) 114. The performance data 120 may comprise performance metrics/results for each of the model snapshots 112A, 112B, 112C, 112D, 112E, and 112F processed by the evaluator component(s) 114.

The evaluation results 118 may provide a basis for selecting parent models from among the model snapshots 112A, 112B, 112C, 112D, 112E, and 112F. Selected parent models may be used to form child models for a subsequent training iteration. FIGS. 1B and 1C depict a controller 130 that includes various components for facilitating selection of parent models and generation of child models. The controller 130 and the components thereof may comprise one or more processing modules of any suitable form.

FIG. 1B depicts the controller 130 as including a selector 132, which may be configured to analyze the evaluation results 118 to select parent models from among the model snapshots 112A, 112B, 112C, 112D, 112E, and 112F, as represented in FIG. 1B by the dashed line extending between the evaluation results 118 and the selector 132. In the example of FIG. 1B, the selector 132 selects model snapshots 112B and 112D for use as parent models based upon the evaluation results 118 (e.g., based upon performance data 120 for the various model snapshots), as indicated in FIG. 1B by the arrows extending from the selector 132 toward bolded representations of model snapshots 112B and 112D. One will appreciate, in view of the present disclosure, that any quantity of parent models may be selected by the selector 132. In one or more embodiments, multiple iterations of parent model selection are performed by the selector 132 to obtain multiple sets of parent models, and final parent models may be selected from the multiple sets of parent models (or parent models represented in multiple sets of parent models may contribute more characteristics to the population of child models).

Various techniques or selection condition(s) 134 may be employed by the selector 132 to facilitate selection of parent models from the model snapshots 112A, 112B, 112C, 112D, 112E, and 112F based on the evaluation results 118, such as greedy selection (selecting the best performer in a batch of model snapshots), binary tournament selection (e.g., selecting the better performer of two randomly selected model snapshots), roulette wheel selection, rank selection, steady state selection, and/or others. In one or more embodiments, binary tournament selection can impose diversity among the selected parent models, which can contribute to improved overall model performance of final models obtained by generalized evolutionary training (e.g., relative to greedy selection).

FIG. 1C depicts the model snapshots 112B and 112D (selected by the selector 132, as shown in FIG. 1B) being defined as parent models 160, as indicated in FIG. 1C by the arrows extending from the model snapshots 112B and 112B toward the parent model(s) 160. FIG. 1C also depicts the parent model(s) 160 being processed by a perturber 136, which is another component of the controller 130 in the example of FIG. 1C. The perturber 136 may be configured to generate one or more child models 140 based upon the parent model(s) 160 and in accordance with perturbation configuration(s) 138. In one or more embodiments, the perturber 136 perturbs model components (e.g., parameters and/or hyperparameters) of the parent model(s) 160 to obtain the child model(s) 140.

The perturbation configuration(s) 138 determine aspects of the perturbations performed by the perturber 136 to obtain the child model(s) 140, such as whether to perturb parameters only, whether to perturb hyperparameters only, whether to perturb both parameters and hyperparameters, which particular parameters and/or hyperparameters to perturb (e.g., per-selected, randomized, probability-based), the magnitude of perturbations to be performed (which can be non-uniform across different parameters and/or hyperparameters), perturbation space (e.g., linear space, log space, etc.), and/or other aspects. By way of illustrative example, an example hyperparameter perturbation may comprise perturbing an original hyperparameter value by plus or minus 20%, and an example parameter perturbation may comprise shrinking an original parameter value toward zero.

In one or more embodiments, perturbations performed by the perturber 136 on model components of the parent model(s) 160 to obtain the child model(s) 140 may implement reproduction techniques associated with evolutionary training, such as crossover, mutation, elitism, recombination, selection, etc. In this regard, a single parent model may function as a parent for a single child model, or a single parent model may function as a parent for multiple child models, or multiple parent models may function as parents for a single child model, or multiple parent models may function as parents for multiple child models.

As noted above, the child model(s) 140 may be utilized in a subsequent training iteration. In the subsequent training iteration, the child model(s) 140 may be processed in a manner that is similar to the treatment of the base model(s) 102 discussed hereinabove. For instance, FIG. 1D depicts the child model(s) 140 being trained by the trainer component(s) 104 (indicated by the arrow extending from the child model(s) 140 to the trainer component(s) 104). The trainer component(s) 104 may train the child model(s) 140 utilizing the training data 106 until the snapshot condition(s) 108 is/are satisfied, at which point model snapshots 142A, 142B, 142C, 142D, 142E, and 142F (or any quantity) of the trained child models may be determined and stored within model storage 110. The model snapshots 142A, 142B, 142C, 142D, 142E, and 142F may comprise parameter and/or hyperparameter states or values associated with the trained child models.

FIG. 1D depicts the model snapshots 142A, 142B, 142C, 142D, 142E, and 142F being received and processed by the evaluator component(s) 114 using evaluation data 116 to provide evaluation results 118. The evaluation results comprise performance data 120 indicating model performance metrics associated with the various model snapshots 142A, 142B, 142C, 142D, 142E, and 142F.

In one or more embodiments, because each of the model snapshots 142A, 142B, 142C, 142D, 142E, and 142F are obtained based upon a trained child model, the model snapshots 142A, 142B, 142C, 142D, 142E, and 142F may indicate genealogical and/or historical information associated with the trained child model, such as states or values of model components for parent models of the trained child models. Such historical and/or genealogical information associated with the model snapshots 142A, 142B, 142C, 142D, 142E, and 142F (and/or their parent model or models) may be regarded as hyperparameter trajectory 122 information, which may be stored (e.g., as metadata) in association with the model snapshots 142A, 142B, 142C, 142D, 142E, and 142F (e.g., with the evaluation results 118).

In one or more embodiments, hyperparameter trajectory 122 is further based upon the performance data 120. For instance, a hyperparameter trajectory 122 for a model snapshot may indicate perturbations that were made to model parameters and/or hyperparameters by the perturber 136 to parent models throughout the genealogy of the model snapshot. The hyperparameter trajectory 122 for a model snapshot may additionally, or alternatively, indicate changes in performance data 120 for the model snapshot throughout the genealogy of the model snapshot (e.g., comparing children to parents throughout the genealogy) and may correlate perturbations with changes in performance. Such hyperparameter trajectory 122 information may be utilized to selectively modify perturbation configuration(s) 138 (e.g., in response to determining that particular perturbation configuration(s) 138 resulted in undesirable effects on performance data 120 for any set of model snapshots).

The hyperparameter trajectory 122 for a model snapshot may additionally, or alternatively, indicate the selection condition(s) 134 that brought about selection of parent models throughout the genealogy of the model snapshot. Selection condition(s) 134 throughout a model snapshot's history may be correlated with changes in model performance. Such hyperparameter trajectory 122 information may be utilized to selectively modify selection condition(s) 134 (e.g., in response to determining that particular selection condition(s) 134 resulted in undesirable effects on performance data 120 for any set of model snapshots).

FIG. 1E depicts the selector analyzing the evaluation results 118 obtained by evaluating performance of the model snapshots 142A, 142B, 142C, 142D, 142E, and 142F. In the example of FIG. 1E, based upon the evaluation results 118, the selector 132 selects model snapshots 142A and 142C as parent models for the next generation. In one or more embodiments, a system (or a user) selectively modifies the selection condition(s) 134 based upon the evaluation results 118 (e.g., based upon the hyperparameter trajectory 122 information).

FIG. 1F depicts the model snapshots 142A and 142C being defined as parent models 160 which are processed by the perturber 136 to obtain the next generation of child models 140. In one or more embodiments, a system (or a user) selectively modifies the perturbation configuration(s) 138 based upon the evaluation results 118 (e.g., based upon the hyperparameter trajectory 122 information). The ellipsis below the child model(s) 140 in FIG. 1F indicates that the processes described with reference to FIGS. 1D through 1F of training child models to obtain model snapshots, evaluating performance of the model snapshots, selecting parent models from among the model snapshots based upon the evaluations, and generating child models by perturbing the parent models may be performed iteratively, such as until one or more convergence conditions are satisfied.

FIG. 1G depicts a conceptual representation of selecting or outputting a final model 148 in response to determining that one or more convergence condition(s) 146 are satisfied. In the example of FIG. 1G, model snapshots 152A, 152B, 152C, 152D, 152E, and 152F are stored within model storage 110 based upon training of child model(s) 140. FIG. 1G depicts evaluation results 118 associated with the model snapshots 152A, 152B, 152C, 152D, 152E, and 152F being assessed by a convergence analyzer 144 (e.g., a component of the controller 130) to determine whether the evaluation results 118 indicate satisfaction of the convergence condition(s) 146 (indicated in FIG. 1G by the dashed line extending from the evaluation results 118 to the convergence analyzer 144).

The convergence condition(s) 146 may take on various forms. In one or more embodiments, the convergence condition(s) 146 is/are based upon a measure of change in performance associated with sequentially generated sets of child model snapshots. For instance, the evaluation results 118 may indicate changes or improvements in model performance between different generations of model snapshots (e.g., marginal changes). Changes in model performance may be determined relative to subsets of model snapshots within each generation, such as the N best performing model snapshots within each generation (other subset selection methodologies may be used). In one or more embodiments, the convergence condition(s) 146 are determined to be satisfied when the change in model performance between (any number of) sequential generations of model snapshots fails to meet or exceed a change threshold (or improvement threshold).

In the example of FIG. 1G, the convergence condition(s) 146 is/are satisfied, and model snapshot 152C is selected as a basis for the final model(s) 148, as indicated in FIG. 1G by the arrows extending from the convergence analyzer 144 to the model snapshot 152C and from the model snapshot 152C to the final model(s) 148. The final model(s) 148 may be deployed for inference, and the generalized evolutionary training process may be completed.

Although FIG. 1G depicts an example in which a single model snapshot 152C is selected for forming the final model(s) 148 in response to the convergence condition(s) 146 being satisfied, one will appreciate that any quantity of model snapshots may be utilized to obtain the final model(s) 148. For instance, components of different model snapshots may be combined or aggregated to form the final model(s) 148, or a set of model snapshots may be selected as candidates for further fine-tuning to obtain the final model(s) 148.

### C. Example Method Embodiments

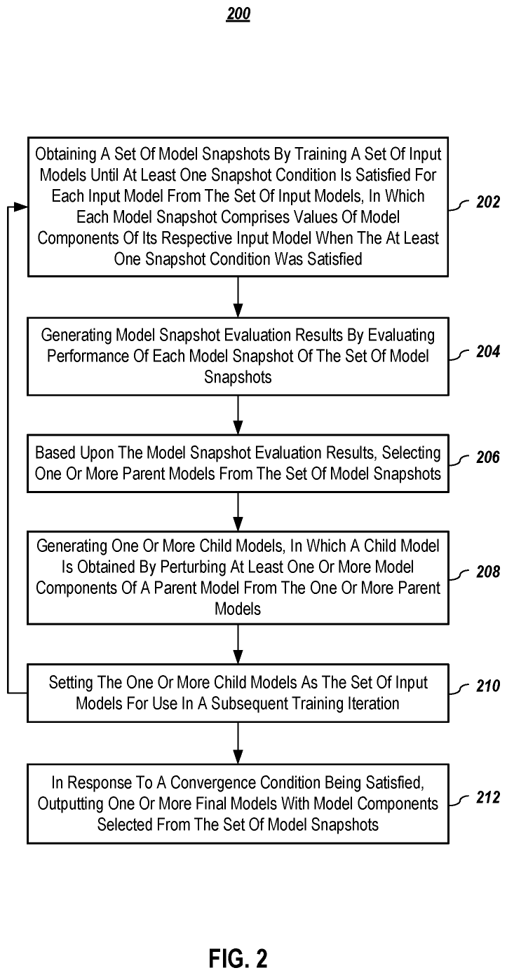

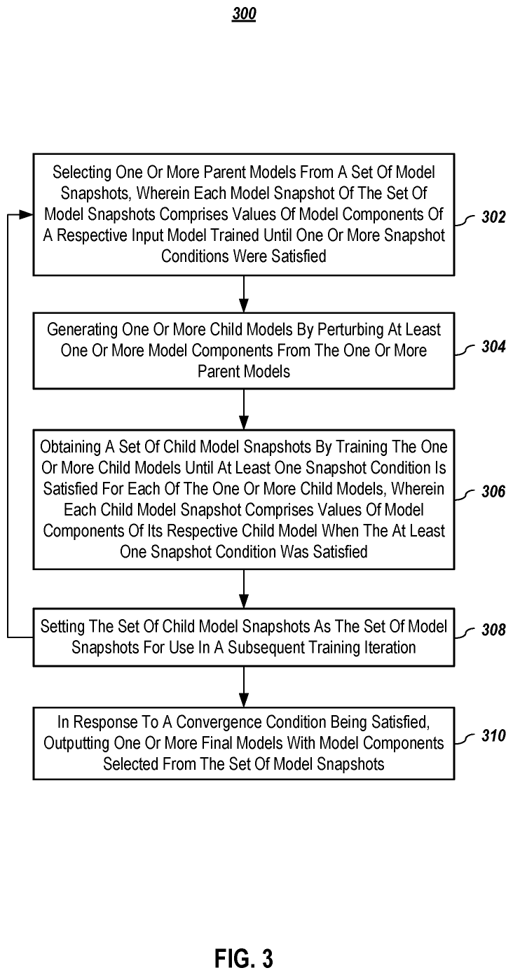

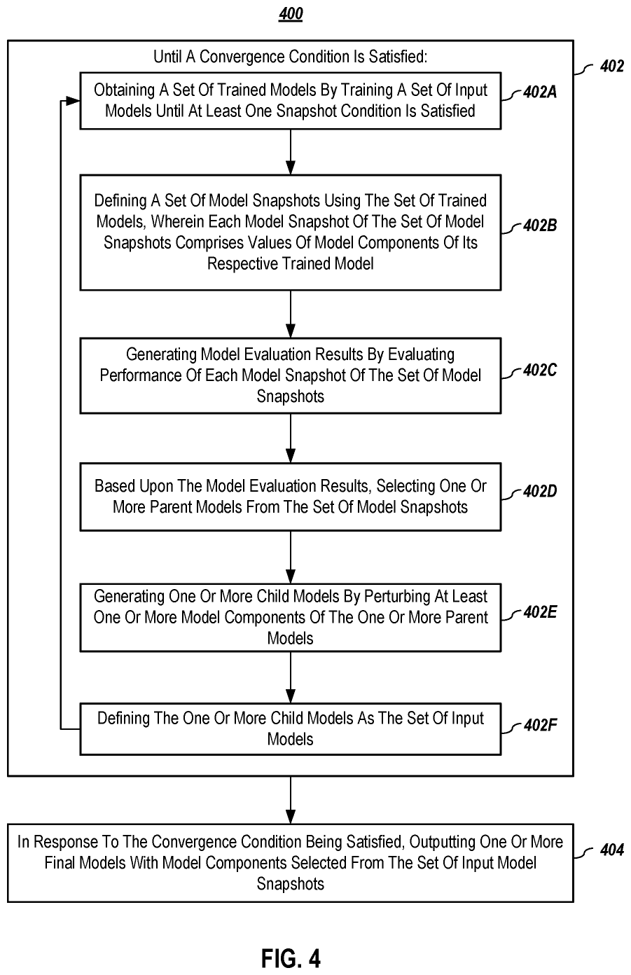

FIG. 2, FIG. 3, and FIG. 4 depict example flow diagrams 200, 300, and 400, respectively, including acts associated with generalized evolutionary training, according to embodiments of the present disclosure. As noted above, (1) certain steps may optionally be performed; (2) steps may not be limited to the specific order set forth herein; (3) certain steps may be performed in different orders; and (4) certain steps may be done concurrently.

Act 202 of flow diagram 200 of FIG. 2 includes obtaining a set of model snapshots by training a set of input models until at least one snapshot condition is satisfied for each input model from the set of input models, in which each model snapshot comprises values of model components of its respective input model when the at least one snapshot condition was satisfied. In one or more embodiments, for a first iteration, the set of input models comprises a set of base models. In one or more embodiments, each model snapshot may be associated with metadata related to its parent model or models (for iterations after the first iteration). In one or more embodiments, the metadata may comprise hyperparameter trajectory information. In one or more embodiments, the at least one snapshot condition may comprise a user-defined snapshot condition.

Act 204 of flow diagram 200 includes generating model snapshot evaluation results by evaluating performance of each model snapshot of the set of model snapshots.

Act 206 of flow diagram 200 includes, based upon the model snapshot evaluation results, selecting one or more parent models from the set of model snapshots. In one or more embodiments, the one or more parent models are selected based upon one or more selection conditions. In one or more embodiments, the one or more selection conditions are determined based upon a hyperparameter trajectory related to the model snapshot and its parent model or models. In one or more embodiments, selecting one or more parent models from the set of model snapshots utilizes greedy selection, binary tournament selection, roulette wheel selection, rank selection, or steady state selection.

Act 208 of flow diagram 200 includes generating one or more child models, in which a child model is obtained by perturbing at least one or more model components of a parent model from the one or more parent models. In one or more embodiments, generating the one or more child models may be performed based upon one or more perturbation configurations. In one or more embodiments, the one or more perturbation configurations are determined based upon a hyperparameter trajectory related to the model snapshot and its parent model or models.

Act 210 of flow diagram 200 includes setting the one or more child models as the set of input models for use in a subsequent training iteration. FIG. 2 depicts an arrow extending from act 210 to act 202 indicating that the set of input models that is set according to act 210 may be trained to obtain another set of model snapshots for the subsequent training iteration.

Act 212 of flow diagram 200 includes, in response to a convergence condition being satisfied, outputting one or more final models with model components selected from the set of model snapshots. In one or more embodiments, the convergence condition is based upon a measure of change in performance associated with sequentially obtained sets of model snapshots. One will appreciate, in view of the present disclosure, that act 212 may be performed at any point throughout performance of the other acts of flow diagram 200.

Act 302 of flow diagram 300 of FIG. 3 includes selecting one or more parent models from a set of model snapshots, wherein each model snapshot of the set of model snapshots comprises values of model components of a respective input model trained until one or more snapshot conditions were satisfied. In one or more embodiments, for a first iteration, the set of model snapshots is obtained by training one or more base models until the one or more snapshot conditions are satisfied for each of the one or more base models. In one or more embodiments, selecting the one or more parent models comprises: (i) generating model snapshot evaluation results by evaluating performance of each model snapshot of the set of model snapshots and (ii) based upon the model snapshot evaluation results, selecting the one or more parent models from the set of model snapshots. In one or more embodiments, selecting one or more parent models from the set of model snapshots utilizes greedy selection, binary tournament selection, roulette wheel selection, rank selection, or steady-state selection.

Act 304 of flow diagram 300 includes generating one or more child models by perturbing at least one or more model components from the one or more parent models.

Act 306 of flow diagram 300 includes obtaining a set of child model snapshots by training the one or more child models until at least one snapshot condition is satisfied for each of the one or more child models, wherein each child model snapshot comprises values of model components of its respective child model when the at least one snapshot condition was satisfied. In one or more embodiments, the at least one snapshot condition comprises a user-defined snapshot condition.

Act 308 of flow diagram 300 includes setting the set of child model snapshots as the set of model snapshots for use in a subsequent training iteration. FIG. 3 depicts an arrow extending from act 308 to act 302 indicating that parent models for the subsequent training iteration may be selected from set of model snapshots that is set according to act 308.

Act 310 of flow diagram 300 includes, in response to a convergence condition being satisfied, outputting one or more final models with model components selected from the set of model snapshots. In one or more embodiments, the convergence condition is based upon a measure of change in performance associated with sequentially obtained sets of model snapshots. One will appreciate, in view of the present disclosure, that act 310 may be performed at any point throughout performance of the other acts of flow diagram 300.

Act 402 of flow diagram 400 of FIG. 4 includes various steps performed until a convergence condition is satisfied.

Step 402A of act 402 of flow diagram 400 includes obtaining a set of trained models by training a set of input models until at least one snapshot condition is satisfied.

Step 402B of act 402 of flow diagram 400 includes defining a set of model snapshots using the set of trained models, wherein each model snapshot of the set of model snapshots comprises values of model components of its respective trained model.

Step 402C of act 402 of flow diagram 400 includes generating model evaluation results by evaluating performance of each model snapshot of the set of model snapshots.

Step 402D of act 402 of flow diagram 400 includes, based upon the model evaluation results, selecting one or more parent models from the set of model snapshots.

Step 402E of act 402 of flow diagram 400 includes generating one or more child models by perturbing at least one or more model components of the one or more parent models.

Step 402F of act 402 of flow diagram 400 includes defining the one or more child models as the set of input models. FIG. 4 depicts an arrow extending from step 402F to step 402A indicating that the set of input models defined according to step 402F may be trained to obtain another set of trained models for a subsequent training iteration.

Act 404 of flow diagram 400 includes, in response to the convergence condition being satisfied, outputting one or more final models with model components selected from the set of input model snapshots. In one or more embodiments, the convergence condition is based upon a measure of change in performance associated with sequentially generated sets of input model snapshots. One will appreciate, in view of the present disclosure, that act 404 may be performed at any point throughout performance of the steps of flow diagram 400.

### D. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

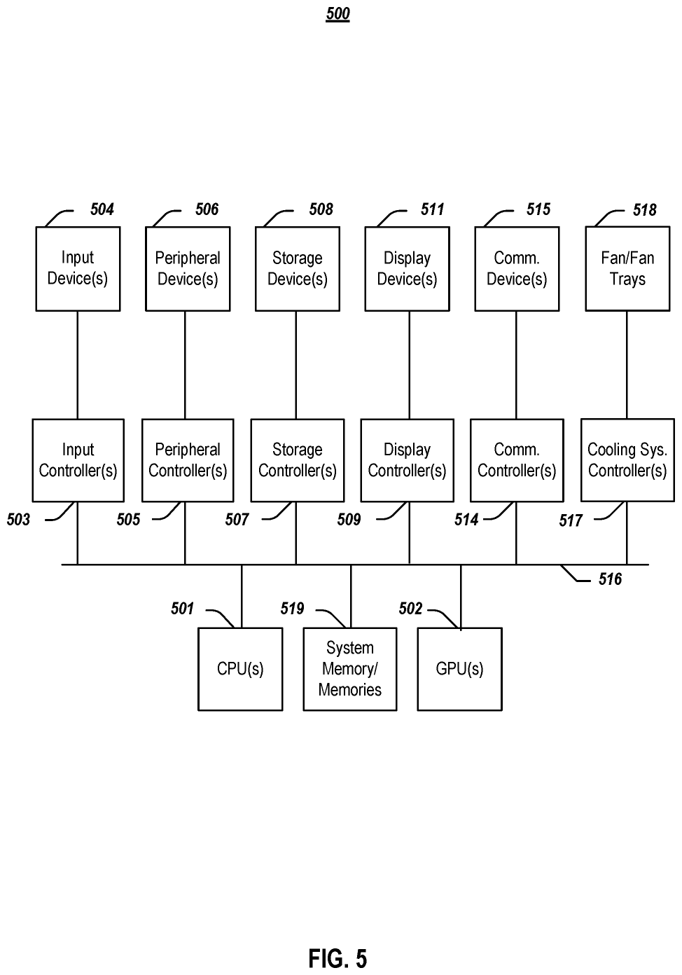

FIG. 5 depicts a simplified block diagram of an information handling system (or computing system), according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provide computing resources and control the computer. CPU 501 may be implemented with a microprocessor or the like and may also include one or more graphics processing units (GPU) 502 and/or a floating-point coprocessor for mathematical computations. In one or more embodiments, one or more GPUs 502 may be incorporated within the display controller 509, such as part of a graphics card or cards. The system 500 may also include a system memory 519, which may comprise RAM, ROM, or both.

A number of controllers and peripheral devices may also be provided, as shown in FIG. 5. An input controller 503 represents an interface to various input device(s) 504. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT) display, a thin film transistor (TFT) display, organic light-emitting diode, electroluminescent panel, plasma panel, or any other type of display. The computing system 500 may also include one or more peripheral controllers or interfaces 505 for one or more peripheral devices 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 500 comprises one or more fans or fan trays 518 and a cooling subsystem controller or controllers 517 that monitors thermal temperature(s) of the system 500 (or components thereof) and operates the fans/fan trays 518 to help regulate the temperature.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for neural network training, comprising:
obtaining a set of model snapshots by training a set of input models until at least one snapshot condition is satisfied for each input model from the set of input models, in which each model snapshot comprises values of model components of its respective input model when the at least one snapshot condition was satisfied;
generating model snapshot evaluation results by evaluating performance of each model snapshot of the set of model snapshots;
based upon the model snapshot evaluation results, selecting one or more parent models from the set of model snapshots;
generating one or more child models, in which a child model is obtained by perturbing at least one or more model components of a parent model from the one or more parent models; and
setting the one or more child models as the set of input models for use in a subsequent training iteration.

2. The computer-implemented method of claim 1, wherein for a first iteration, the set of input models comprises a set of base models.

3. The computer-implemented method of claim 1, wherein each model snapshot is associated with metadata related to its parent model or models.

4. The computer-implemented method of claim 3, wherein the metadata comprises hyperparameter trajectory information.

5. The computer-implemented method of claim 1, wherein the one or more parent models are selected based upon one or more selection conditions.

6. The computer-implemented method of claim 5, wherein the one or more selection conditions are determined based upon a hyperparameter trajectory related to the model snapshot and its parent model or models.

7. The computer-implemented method of claim 1, wherein generating the one or more child models is performed based upon one or more perturbation configurations.

8. The computer-implemented method of claim 7, wherein the one or more perturbation configurations are determined based upon a hyperparameter trajectory related to the model snapshot and its parent model or models.

9. The computer-implemented method of claim 1, wherein selecting one or more parent models from the set of model snapshots utilizes greedy selection, binary tournament selection, roulette wheel selection, rank selection, or steady state selection.

10. The computer-implemented method of claim 1, wherein the at least one snapshot condition comprises a user-defined snapshot condition.

11. The computer-implemented method of claim 1, further comprising:
in response to a convergence condition being satisfied, outputting one or more final models with model components selected from the set of model snapshots.

12. The computer-implemented method of claim 11, wherein the convergence condition is based upon a measure of change in performance associated with sequentially obtained sets of model snapshots.

13. A computer-implemented method for neural network training, comprising:
selecting one or more parent models from a set of model snapshots, wherein each model snapshot of the set of model snapshots comprises values of model components of a respective input model trained until one or more snapshot conditions were satisfied;
generating one or more child models by perturbing at least one or more model components from the one or more parent models;
obtaining a set of child model snapshots by training the one or more child models until at least one snapshot condition is satisfied for each of the one or more child models, wherein each child model snapshot comprises values of model components of its respective child model when the at least one snapshot condition was satisfied; and
setting the set of child model snapshots as the set of model snapshots for use in a subsequent training iteration.

14. The computer-implemented method of claim 13, wherein for a first iteration, the set of model snapshots is obtained by training one or more base models until the one or more snapshot conditions are satisfied for each of the one or more base models.

15. The computer-implemented method of claim 13, wherein selecting the one or more parent models from the set of model snapshots comprises:
generating model snapshot evaluation results by evaluating performance of each model snapshot of the set of model snapshots; and
based upon the model snapshot evaluation results, selecting the one or more parent models from the set of model snapshots.

16. The computer-implemented method of claim 15, wherein selecting one or more parent models from the set of model snapshots utilizes greedy selection, binary tournament selection, roulette wheel selection, rank selection, or steady state selection.

17. The computer-implemented method of claim 13, wherein the at least one snapshot condition comprises a user-defined snapshot condition.

18. The computer-implemented method of claim 13, further comprising:
in response to a convergence condition being satisfied, outputting one or more final models with model components selected from the set of model snapshots.

19. The computer-implemented method of claim 18, wherein the convergence condition is based upon a measure of change in performance associated with sequentially obtained sets of child model snapshots.

20. A computer-implemented method for neural network training, comprising:
until a convergence condition is satisfied:
obtaining a set of trained models by training a set of input models until at least one snapshot condition is satisfied;
defining a set of model snapshots using the set of trained models, wherein each model snapshot of the set of model snapshots comprises values of model components of its respective trained model;
generating model evaluation results by evaluating performance of each model snapshot of the set of model snapshots;
based upon the model evaluation results, selecting one or more parent models from the set of model snapshots;
generating one or more child models by perturbing at least one or more model components of the one or more parent models; and
defining the one or more child models as the set of input models; and
in response to the convergence condition being satisfied, outputting one or more final models with model components selected from the set of model snapshots.
